(19) United States
(12) Patent Application Publication
(10) Pub. No.: US 2009/0214816 A1
(43) Pub. Date: Aug. 27, 2009

(54) Aligned Carbon Nanotube Bulk Structure Having Portions Different in Density, Process for Producing The Same and Uses thereof

(76) Inventors: Kenji Hata, Ibaraki (JP); Don N. Futaba, Ibaraki (JP); Motoo Yumura, Ibaraki (JP); Sumio Iijima, Ibaraka (JP)

Correspondence Address: WENDEROTH, LIND & PONACK, L.L.P., 1030 15th Street, N.W.,, Suite 400 East, Washington, DC, 20005-1503, US

(21) Appl. No.: 12/087,451

(22) PCT Filed: Jan. 5, 2007
(86) PCT No.: PCT/JP2007/050049

§ 371 Date: Oct. 8, 2008

(30) Foreign Application Priority Data
Jan. 6, 2006 (JP) 2006-001905

(51) Int. Cl. D01F 9/12; B32B 5/12

(52) U.S. Cl. 428/114; 423/447.2; 423/447.1; 977/750; 977/752

(57) ABSTRACT

An aligned carbon nanotube bulk structure having portions different in density of the invention is characterized by being composed of carbon nanotubes aligned in a predetermined direction and having both a high-density portion of 0.2 to 1.5 g/cm³ and a low-density portion of 0.001 to 0.2 g/cm³. The carbon nanotube bulk structure can be produced by a process of growing carbon nanotubes by chemical vapor deposition (CVD) in the presence of a metal catalyst which comprises growing carbon nanotubes in an aligned state in a reaction atmosphere, soaking the obtained carbon nanotubes with a liquid, and then drying the resulting nanotubes. The invention provides aligned carbon nanotube bulk structure controlled in various properties such as density and hardness in sites thereof, and a process for the production of the same; and application thereof.

### TECHNICAL FIELD

The present invention relates to an aligned carbon nanotube bulk structure having portions different in density and a process for producing the same, and to uses thereof. In more detail, the present invention relates to an aligned carbon nanotube bulk structure having portions composed of aligned carbon nanotubes capable of realizing high density, high hardness, high purity, high specific surface area, large scaling and patterning, an aspect of which has not hitherto been achieved, and to a process for producing the same and to use thereof.

### BACKGROUND ART

Regarding carbon nanotubes (CNT) that are expected for development to functional materials as novel electronic device materials, optical materials, electrically conductive materials, biotechnology related materials and others, energetic investigations of their yield, quality, use, mass productivity and production method are being promoted.

For putting carbon nanotubes into practical use for the above-mentioned functional materials, one method may be taken into consideration, which comprises preparing a bulk aggregate of a large number of carbon nanotubes, large-scaling the size of the bulk aggregate, and improving its properties such as the purity, the specific surface area, the electric conductivity, the density and the hardness to thereby make it patternable in a desired shape. In addition, the mass productivity of carbon nanotubes must be increased greatly.

To solve the above-mentioned problems, the inventors of this application have assiduously studied and, as a result, have found that, in a process of chemical vapor deposition (CVD) where carbon nanotubes are grown in the presence of a metal catalyst, when a very small amount of water vapor is added to the reaction atmosphere, then an aligned carbon nanotube bulk structure having a high purity and having extremely large-scaled as compared with that in conventional methods can be obtained, and have reported it in Non-Patent Document 1, etc.

Non-Patent Document 1: Kenji Hata et al., Water-Assisted Highly Efficient Synthesis of Impurity-Free Single-Walled Carbon Nanotubes, SCIENCE, 2004.11.19, Vol. 306, pp. 1362-1364.

### DISCLOSURE OF THE INVENTION

### Problems to be Solved by the Invention

The aligned carbon nanotube bulk aggregate reported in the above-mentioned Non-Patent Document 1 has, for example, a purity before purification of 99.98 mass % and a specific surface area of about 1000 m²/g, and has a height (length) of about 2.5 mm or so, which comprises a large Dumber of single-walled carbon nanotubes growing as aggregated.

However, in order to apply the aligned carbon nanotube bulk structure as a functional material having much better properties, its strength and hardness must be further improved since the density of the structure of the above-mentioned report must is about 0.03 g/cm³ or so and it is mechanically brittle. In addition, there is room for further investigation of the structure in point of the handlability and the workability thereof.

When a patterned aligned carbon nanotube bulk structure is applied to various articles that utilize its electric properties, thermal properties, mechanical properties, gas absorbability, or the like, in some cases, it is preferably used as a bulk structure of which the properties such as the density and the hardness are controlled in sites thereof. In addition, the shape of the aligned carbon nanotube bulk structure is also desired to be readily controllable to a desired shape, while keeping the excellent properties that the carbon nanotubes have. In fact, however, the aligned carbon nanotube bulk structures heretofore proposed could not satisfy the requirements.

With the background described above, therefore, an object of the present application is to provide an aligned carbon nanotube bulk structure of which the properties such as the density and the hardness are controlled in sites thereof, and to provide its production process and its sue.

Another object of the present application is to provide an aligned carbon nanotube bulk structure capable being readily patterned in a desired shape while keeping the excellent properties that the carbon nanotubes have, and to provide its production process and its application.

For the purpose of solving the foregoing problems, this application provides the following inventions.

(1) An aligned carbon nanotube bulk structure having portions different in density, in which plural carbon nanotubes are aligned in a predetermined direction and which has a high-density portion having a density of from 0.2 to 1.5 g/cm³ and a low-density portion having a density of from 0.001 to 0.2 g/cm³.

(2) The aligned carbon nanotube bulk structure having portions different in density according the above (1), which has one or more intermediate density portions falling between the high-density portion and the low-density portion.

(3) The aligned carbon nanotube bulk structure having portions different in density according the above (1), wherein the high-density portion and the low-density portion are disposed regularly.

(4) The aligned carbon nanotube bulk structure having portions different in density according the above (1), wherein the high-density portion and the low-density portion and the intermediate-density portion are disposed regularly.

(5) An aligned carbon nanotube bulk structure having portions different in density, in which plural carbon nanotubes are aligned in a predetermined direction and of which the density continuously or stepwise changes between the highest-density portion having a density of from 0.2 to 1.5 g/cm³ and a lowest-density portion having a density of from 0.001 to 0.2 g/cm³.

(6) The aligned carbon nanotube bulk structure having portions different in density according to any one of the above (1) to (5), wherein the carbon nanotubes are single-walled carbon nanotubes.

(7) The aligned carbon nanotube bulk structure having portions different in density according to any one of the above (1) to (5), wherein the carbon nanotubes are double-walled carbon nanotubes.

(8) The aligned carbon nanotube bulk structure having portions different in density according to any one of the above (1) to (5), wherein the carbon nanotubes are a mixture of single-walled carbon nanotubes and double-walled or more multi-walled carbon nanotubes.

(9) The aligned carbon nanotube bulk structure having portions different in density according to any one of the above (1) to (8), which has a purity of at least 98 mass %.

(10) The aligned carbon nanotube bulk structure having portions different in density according to any one of the above (1) to (9), the high-density portion of which has a specific surface area of from 600 to 2600 m²/g.

(11) The aligned carbon nanotube bulk structure having portions different in density according to any one of the above (1) to (9), the high-density portion of which is unopened and which has a specific surface area of from 600 to 1300 m²/g.

(12) The aligned carbon nanotube bulk structure having portions different in density according to any one of the above (1) to (9), the high-density portion of which is opened and which has a specific surface area of from 1300 to 2600 m²/g.

(13) The aligned carbon nanotube bulk structure having portions different in density according to any one of the above (1) to (12), the high-density portion of which is a mesoporous material having a packing ratio of from 5 to 50%.

(14) The aligned carbon nanotube bulk structure having portions different in density according to any one of the above (1) to (13), the high-density portion of which has a mesopore diameter of from 1.0 go 5.0 nm.

(15) The aligned carbon nanotube bulk structure having portions different in density according to any one of the above (1) to (14), the high-density portion of which has a Vickers hardness of from 5 to 100 RV.

(16) The aligned carbon nanotube bulk structure having portions different in density according to any one of the above (1) to (15), the high-density portion of which is vertically aligned or horizontally aligned on a substrate.

(17) The aligned carbon nanotube bulk structure having portions different in density according to any one of the above (1) to (15), the high-density portion of which is aligned on a substrate in the direction oblique to the substrate surface.

(18) The aligned carbon nanotube bulk structure having portions different in density according to any one of the above (1) to (17), the high-density portion of which has anisotropy between the alignment direction and the direction vertical thereto, in at least any of optical properties, electric properties, mechanical properties and thermal properties.

(19) The aligned carbon nanotube bulk structure having portions different in density according to any one of the above (1) to (18), wherein the degree of anisotropy of the high-density portion between the alignment direction and the direction vertical thereto is at most ⅕ in terms of the ratio of the small value to the large value.

(20) The aligned carbon nanotube bulk structure having portions different in density according to any one of the above (1) to (19), wherein the intensity ratio of any of the (100), (110) and (002) peaks of the high-density portion in the alignment direction and in the direction vertical thereto in X-ray diffraction is from ½ to 1/100 in terms of the ratio of the small value to the large value.

(21) The aligned carbon nanotube bulk structure having portions different in density according to any one of the above (1) to (20), wherein the shape of the high density portion is a thin film.

(22) The aligned carbon nanotube bulk structure having portions different in density according to any one of the above (1) to (20), wherein the shape of the high-density portion is a columnar one having a circular, oval or n-angled cross section (n is an integer of at least 3).

(23) The aligned carbon nanotube bulk structure having portions different in density according to any one of the above (1) to (20), wherein the shape of the high-density portion is a block.

(24) The aligned carbon nanotube bulk structure having portions different in density according to any one of the above (1) to (20), wherein the shape of the high-density portion is a needle-like one.

(25) A process for producing an aligned carbon nanotube bulk structure having portions different in density according to any one of the above (1) to (24) through chemical vapor deposition (CVD) of carbon nanotubes in the presence of a metal catalyst, wherein plural carbon nanotubes are grown, as aligned, then a part of the resulting plural carbon nanotubes are exposed to liquid and thereafter dried, thereby producing an aligned carbon nanotube bulk structure having a high-density portion having a density of from 0.2 to 1.5 g/cm³ and a low-density portion having a density of from 0.001 to 0.2 g/cm³.

(26) The process for producing an aligned carbon nanotube bulk structure having portions different in density according to the above (25), wherein the starting point to be exposed to liquid is changed to thereby produce an aligned carbon nanotube bulk structure having a different shape.

(27) The process for producing an aligned carbon nanotube bulk structure having portions different in density according to the above (25) or (26), wherein in exposing plural carbon nanotubes to liquid and drying them, pressure of a different level is given thereto in different directions.

(28) The process for producing an aligned carbon nanotube bulk structure having portions different in density according to any one of the above (25) to (27), wherein the shape of the aligned carbon nanotube bulk structure is controlled by a shaping mold.

(29) A functional product comprising an aligned carbon nanotube bulk structure having portions different in density, in which plural carbon nanotubes are aligned in a predetermined direction and which has a high-density portion having a density of from 0.2 to 1.5 g/cm³ and a low-density portion having a density of from 0.001 to 0.2 g/cm³.

(30) The functional product according to the above (29), which is a brush for cleaning and in which the high-density portion is formed as an axis, and from its one end, the low-density portion expands like plural hairs.

(31) The functional product according to the above (29), which is a motor brush.

(32) The functional product according to the above (29), which is a motor commutator.

(33) The functional product according to the above (29), which is an electric contact of motor.

(34) The functional product according to the above (29), which constitutes a slide member.

(35) The functional product according to the above (29), which is an optical member.

### EFFECT OF THE INVENTION

The aligned carbon nanotube bulk structure of the present invention is an unprecedented high-strength aligned carbon nanotube bulk structure having a high-density portion and a low-density portion. The density of the high-density portion is at least about 20 times that of the aligned carbon nanotube bulk structure that the inventors of this application proposed in Non-Patent Document 1, and is extremely high (at least 0.2 g/cm³). The hardness of the high-density portion is at least about 100 times that of the previous one and is extremely large; and this is not a material having a soft feeling but is a novel material that exhibits a phase of so-called “solid”.

The high-density portion of the aligned carbon nanotube bulk structure of the present invention is a highly purified one and its contamination with catalyst and side product is inhibited. Its specific surface area is from 600 to 2600 m²/g or so, and is on the same level as that of typical porous materials, activated carbon and SBA-15. Though ordinary porous materials are insulators, the aligned carbon nanotube bulk structure of the present invention has high electric conductivity and, when formed into a sheet, it is flexible. When the aligned carbon nanotube bulk aggregate produced in Non-Patent Document 1 is formed into an aligned carbon nanotube bulk structure, then a material having a carbon purity of at least 99.98% could be produced.

The aligned carbon nanotube bulk structure of the present invention has excellent characteristics in purity, density, hardness, specific surface area, and workability, and can be large-scaled. Accordingly, the present invention is expected to be applicable to various uses such as a commutator, brush and contact of a micro-motor, a fine cleaning kit (brush-like member) for removing fine dust generated in the industrial process, and the like.

Further, according to the process for producing an aligned carbon nanotube bulk structure of the present invention, an aligned carbon nanotube bulk structure, which has excellent properties as above and which is expected to be acceptable in various applications, can be produced with good producibility according to a simple method of chemical vapor deposition (CVD).

### BRIEF DESCRIPTION OF THE DRAWINGS

FIG. 1 shows electron microscopic (SEM) images of a high-density portion of an aligned carbon nanotube bulk structure.

FIG. 2 shows X-ray diffraction data of a high-density portion of an aligned carbon nanotube bulk structure.

FIG. 3 shows an example of low-angle X-ray diffraction data in a case where a high-density portion of an aligned carbon nanotube bulk structure is irradiated with X rays in the direction vertical to the alignment direction.

FIG. 4 shows liquid nitrogen adsorption/desorption isothermal curves of a high-density portion of an aligned carbon nanotube bulk structure.

FIG. 5 shows the adsorption per unit volume of a high-density portion of an aligned carbon nanotube bulk structure.

FIG. 6 shows a relation between the adsorption per unit volume of a high-density portion of an aligned carbon nanotube bulk structure and the specific surface area per unit weight thereof.

FIG. 7 shows an example of evaluated results of Raman spectrometry of a high-density portion of an aligned carbon nanotube bulk structure.

FIG. 8 shows the appearance of plural aligned carbon nanotubes before exposure to liquid and after exposure to liquid followed by drying.

FIG. 9 shows images indicating the change the appearance of plural aligned carbon nanotubes before exposure to liquid and after exposure to liquid followed by drying.

FIG. 10 shows Raman spectrum data after exposure of plural aligned carbon nanotubes to water followed by drying them.

FIG. 11 shows some examples of the shape of an aligned carbon nanotube bulk structure.

FIG. 12 shows a structure of the CNT brush of Example 1.

FIG. 13 is a conceptual view of a case of comparing the friction property of the CNT brush of Example 1 with that of a conventional silicon nitride ball.

FIG. 14 is a graph showing the results of comparison between the friction property of the CNT brush of Example 1 and that of a conventional silicon nitride ball.

FIG. 15 shows the electric contact for motor in Example 2.

FIG. 16 is an explanatory view of a test with the electric contact for motor in Example 2.

### BEST MODE FOR CARRYING OUT THE INVENTION

The present invention has the above-mentioned characteristics, and its embodiments will be described hereinunder.

The aligned carbon nanotube bulk structure of the present invention is one produced by patterning an aligned carbon nanotube bulk aggregate where plural carbon nanotubes are aligned in a predetermined direction, and is characterized by comprising a high-density portion and a low-density portion.

Typical embodiments of the aligned carbon nanotube bulk structure are the following:

<1> It comprises a high-density portion and a low-density portion, in which the lowermost limit of the density of the high-density portion is 0.2 g/cm³, more preferably 0.3 g/cm³, even more preferably 0.4 g/cm³, the uppermost limit thereof is 1.0 g/cm³, more preferably 1.2 g/cm³, even more preferably 1.5 g/Cm³; and the lowermost limit of the density of the low-density portion is 0.001 g/cm³, more preferably 0.005 g/cm³, even more preferably 0.01 g/cm³, the uppermost limit thereof is 0.05 g/cm³, more preferably 0.1 g/cm³, even more preferably 0.2 g/cm³.

<2> In the above <1>, the structure has one or more intermediate-density portions falling between the high-density portion and the low-density portion.

<3> The density continuously changes between the highest-density portion where the lowermost limit of the density is 0.2 g/cm³, more preferably 0.3 g/cm³, even more preferably 0.4 g/Cm³ and the uppermost limit thereof is 1.0 g/cm³, more preferably 1.2 g/cm³, even more preferably 1.5 g/cm³, and the lowest-density portion where the lowermost limit of the density is 0.001 g/cm³, more preferably 0.005 g/cm³, even more preferably 0.01 g/cm³ and the uppermost limit thereof is 0.05 g/cm³, more preferably 0.1 g/cm³, even more preferably 0.2 g/cm³.

<4> The density stepwise changes between the highest-density portion where the lowermost limit of the density is 0.2 g/cm³, more preferably 0.3 g/Cm³, even more preferably 0.4 g/cm³ and the uppermost limit thereof is 1.0 g/Cm³, more preferably 1.2 g/cm³, even more preferably 1.5 g/cm³, and the lowest-density portion where the lowermost limit of the density is 0.001 g/cm³, more preferably 0.005 g/Cm³, even more preferably 0.01 g/cm³ and the uppermost limit thereof is 0.05 g/cm³, more preferably 0.1 g/cm³, even more preferably 0.2 g/cm³.

The aligned carbon nanotube bulk structure of the present invention is expected to be applicable to various fields such as optical field, electric and electronic field, machinery field and energy storage field capable of utilizing the characteristics of the high-density portion of carbon nanotubes and those of the low-density portion thereof.

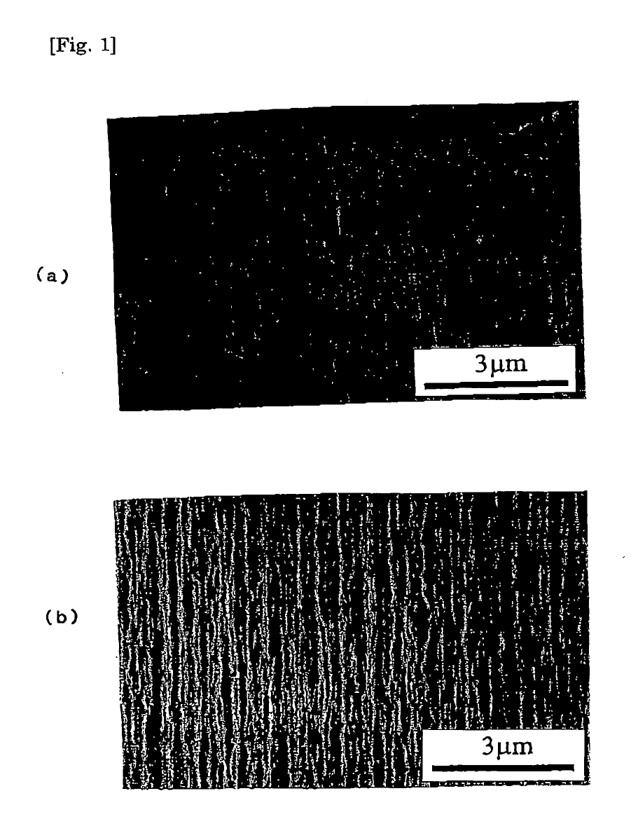

The density range of the high-density portion of the aligned carbon nanotube bulk structure of the present invention is a range necessary for making the structure have a sufficient mechanical strength; and the high-density portion of the aligned carbon nanotube bulk structure having such a density is not a soft-feeling material but exhibits a phase of so-called “solid”. The density of the high-density portion is extremely larger than the density of heretofore-proposed aligned carbon nanotube bulk structures. FIG. 1 shows an electron microscopic (SEM) image (a) of a high-density portion of an aligned carbon nanotube bulk structure of the present invention, as compared with a photographic image (b) of an aligned carbon nanotube bulk structure produced in Non-Patent Document 1 (hereinafter this may be referred to as previously-proposed aligned carbon nanotube bulk structure). In this example, the density of the high-density portion of the aligned carbon nanotube bulk structure of the present invention is about 20 times larger than the density of the previously-proposed aligned carbon nanotube bulk structure.

The density range of the low-density portion of the aligned carbon nanotube bulk structure of the present invention is a range that makes it possible to utilize properties different from those of the high-density portion.

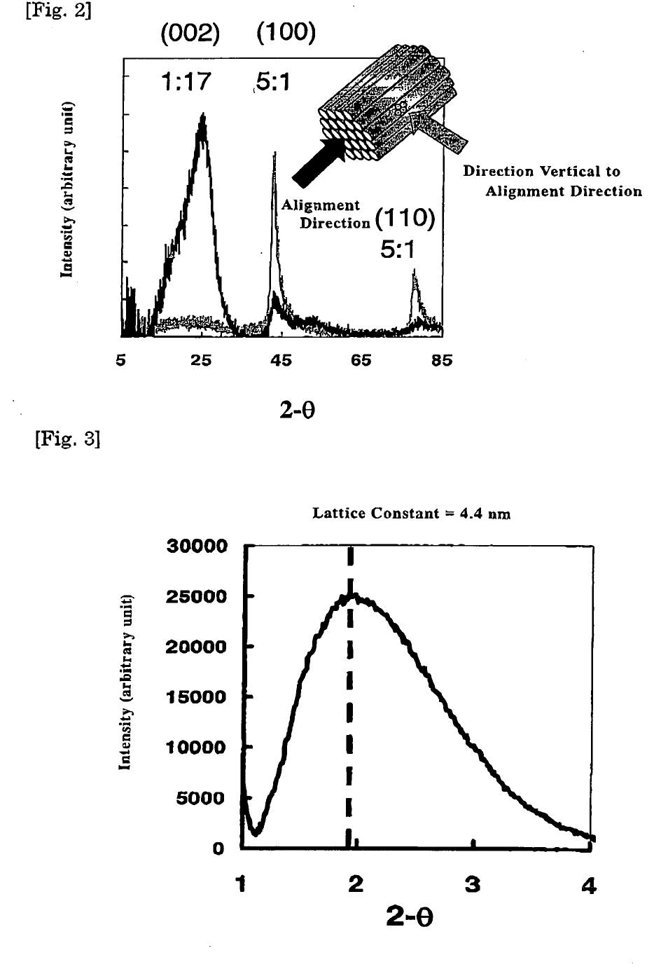

FIG. 2 shows X-ray diffraction data of a high-density portion of an aligned carbon nanotube bulk structure of the present invention. In the drawing, L indicates the data of the aligned carbon nanotube bulk structure irradiated with X rays in the alignment direction; and T indicates the data thereof irradiated with X rays in the direction vertical to the alignment direction. The intensity ratio of the (100), (110) and (002) diffraction peaks in the L direction and the T direction of the X-ray diffraction data confirms good alignment. Regarding the (100) and (110) peaks, the intensity is higher in the case of X ray irradiation in the direction vertical to the alignment direction (T direction) than in the case of X ray irradiation in the alignment direction (L direction); and the intensity ratio is, for example, in the case of FIG. 2, 5:1 at both the (100) peak and the (110) peak. This is because, in the case of X ray irradiation in the direction vertical to the alignment direction (T direction), the graphite lattices constituting carbon nanotubes are seen. On the contrary, in the case of the (002) peak by X ray irradiation in the alignment direction (L direction), the intensity is higher than that in the case of X ray irradiation in the direction vertical to the alignment direction (T direction); and the intensity ratio is, for example, in the case of FIG. 2, 17:1. This is because, in the case of X ray irradiation in the alignment direction (L direction), the contact points of carbon nanotubes are seen.

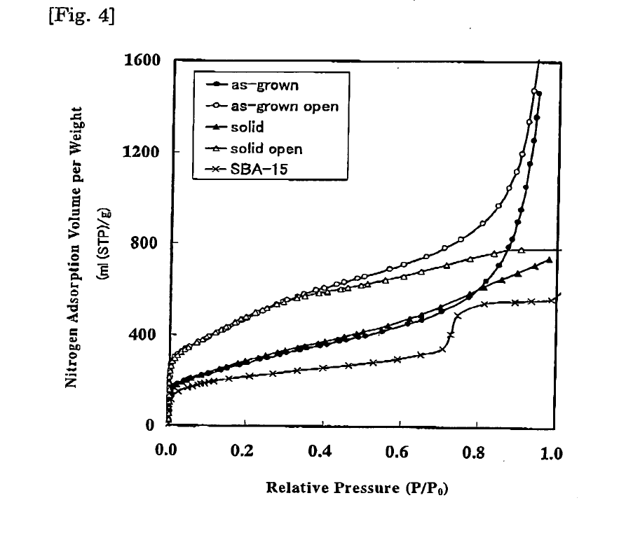

FIG. 3 shows an example of low-angle X-ray diffraction data in a case where a high-density portion of an aligned carbon nanotube bulk structure of the present invention is irradiated with X rays in the alignment direction (L direction). It is known that the case of this example is a structure having a lattice constant of about 4.4 nm.

The carbon nanotubes that constitute the high-density portion of the aligned carbon nanotube bulk structure of the present invention may be single-walled carbon nanotubes or double-walled carbon nanotubes, or may also be in the form of a mixture of single-walled carbon nanotubes and double-walled or more multi-walled carbon nanotubes in a suitable ratio.

Regarding the production process for the aligned carbon nanotube bulk structure of the present invention, the structure may be produced according to the process of the invention of above-mentioned [25] to [28], and its details are described hereinunder. In case where the aligned carbon nanotube bulk structure obtained according to the process is used in an application in which the purity thereof is taken into consideration, its purity can be preferably at least 98 mass %, more preferably at least 99 mass %, even more preferably at least 99.9 mass %. When the production process that the inventors of this application proposed in Non-Patent Document 1 is utilized, then an aligned carbon nanotube bulk structure having a high purity as above can be obtained even though it is not processed for purification. The aligned carbon nanotube bulk structure having such a high purity contains few impurities, and therefore it may exhibit the properties intrinsic to carbon nanotubes.

The purity as referred to in this description is represented by mass % of carbon nanotubes in a product. The impurity may be obtained from the data of elementary analysis with fluorescent X rays.

A preferred range of the height (length: dimension of carbon nanotubes in the lengthwise direction) of the aligned carbon nanotube bulk structure of the present invention varies, depending on the application thereof. In case where it is used as a large-scaled one, the lowermost limit of the range is preferably 5 μm, more preferably 10 μm, even more preferably 20 μm; and the uppermost limit thereof is preferably 2.5 mm, more preferably 1 cm, even more preferably 10 cm.

The high-density portion of the aligned carbon nanotube bulk structure of the present invention has an extremely large specific surface area, and its preferred value varies depending on the use of the structure. For applications that require a large specific surface area, the specific surface area is preferably from 600 to 2600 m²/g, more preferably from 800 to 2600 m²/g, even more preferably from 1000 to 2600 m²/g. The high-density portion of the carbon nanotube bulk structure of the present invention that is unopened preferably has a specific surface area of from 600 to 1300 m²/g, more preferably from 800 to 1300 m²/g, even more preferably from 1000 to 1300 m²/g. The high-density portion of the aligned carbon nanotube bulk structure of the present invention that is opened preferably has a specific surface area of from 1300 to 2600 m²/g, more preferably from 1500 to 2600 m²/g, even more preferably from 1700 to 2600 m²/g.

The specific surface area may be determined through computation of adsorption/desorption isothermal curves. One example is described with reference to 50 mg of a high-density portion of an aligned carbon nanotube bulk structure of the present invention. Using Nippon Bell's BELSORP-MINI, liquid nitrogen adsorption/desorption isothermal curves were drawn at 77 K (see FIG. 4). (The adsorption equilibrium time was 600 seconds). The specific surface area was computed from the adsorption/desorption isothermal curves, and it was about 1100 M²/g. In the relative pressure region of at most 0.5, the adsorption/desorption isothermal curves showed linearity, and this confirms that the carbon nanotubes in the aligned carbon nanotube bulk structure are unopened.

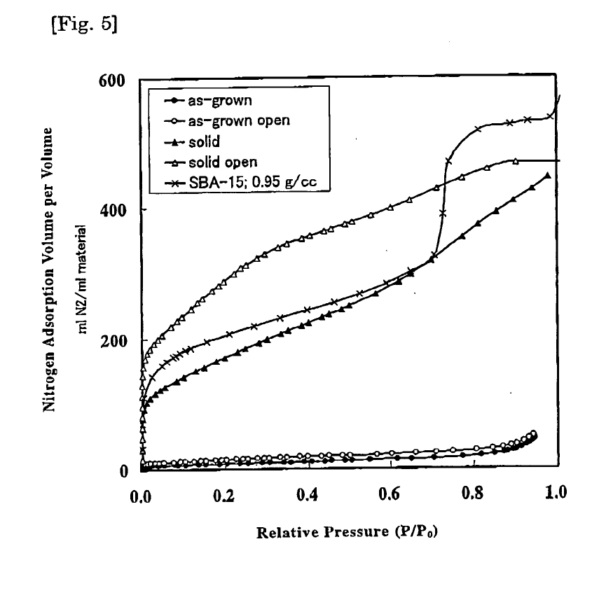

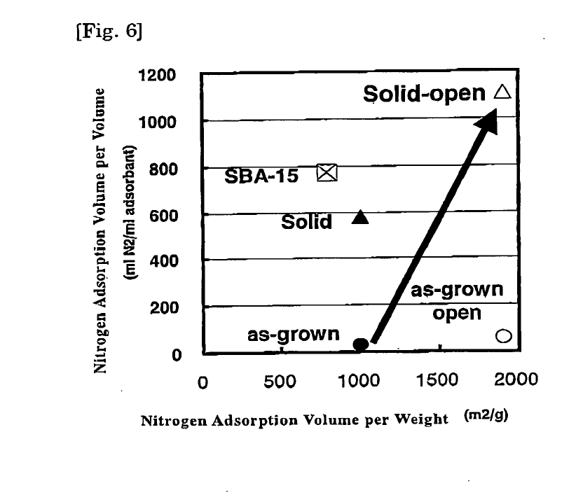

When the high-density portion of the aligned carbon nanotube bulk structure of the present invention is processed for opening, then the top end of the carbon nanotube is opened to thereby increase the specific surface area thereof. In FIG. 4, ▴ indicates the data of an unopened carbon nanotube of the high-density portion of the aligned carbon nanotube bulk structure of the present invention; Δ indicates the data of an opened one thereof; indicates the data of an unopened, previously-proposed aligned carbon nanotube bulk structure; ∘ indicates the data of an opened one thereof; x indicates the data of mesoporous silica (SBA-15). The opened high-density portion of the aligned carbon nanotube bulk structure of the present invention realized an extremely large specific surface area of about 1900 m²/g. FIG. 5 shows the adsorption per unit volume; and FIG. 6 shows a relation between the adsorption per unit volume and the specific surface area per unit weight. From these drawings, it is known that the high-density portion of the aligned carbon nanotube bulk structure of the present invention has a large specific surface area and good adsorption capability.

For the opening treatment, employable is a dry process of treatment with oxygen, carbon dioxide or water vapor. In case where a wet process is employable for it, it may comprise treatment with an acid, concretely refluxing treatment with hydrogen peroxide or cutting treatment with high-temperature hydrochloric acid.

The aligned carbon nanotube bulk structure having such a large specific surface area exhibits great advantages in various applications. When the specific surface area is too small and when the structure having such a small specific surface area is used in the above-mentioned applications, then the devices could not have desired properties. The uppermost limit of the specific surface area is preferably as high as possible, but is theoretically limited.

The high-density portion of the aligned carbon nanotube bulk structure of the present invention may be in the form of a mesoporous material having a packing ratio of from 5 to 50%, more preferably from 10 to 40%, even more preferably from 10 to 30%. In this case, the material preferably contains those having a mesopore diameter of from 1.0 to 5.0 nm. The mesopores in this case are defined by the size thereof in the aligned carbon nanotube bulk structure. When the carbon nanotubes in the aligned carbon nanotube bulk structure are opened through oxidation treatment or the like, and when liquid nitrogen adsorption/desorption isothermal curves of the structure are prepared and SF plots are obtained from the adsorption curves, then the mesopores corresponding to the size of the carbon nanotubes may be computed. On the contrary, from the above-mentioned experimental facts, it is known that the opened high-density portion of the aligned carbon nanotube bulk structure can function as a mesopore material. The packing ratio in the mesopores may be defined by the coating ratio of the carbon nanotubes. When the packing ratio or the mesopore size distribution falls within the above range, then the aligned carbon nanotube bulk structure is favorably used in applications of a mesoporous material and may have a desired strength.

An ordinary mesoporous material is an insulator, but the high-density portion of the aligned carbon nanotube bulk structure of the present invention has high electric conductivity and, when formed into a sheet, it is flexible.

The Vickers hardness of the high-density portion of the aligned carbon nanotube bulk structure of the present invention is preferably from 5 to 100 HV. The Vickers hardness falling within the range is a sufficient mechanical strength comparable to that of typical mesoporous materials, active carbon and SBA-15, and exhibits great advantages in various applications that require mechanical strength.

The aligned carbon nanotube bulk structure of the present invention may be provided on a substrate, or may not be thereon. In case where it is provided on a substrate, it may be aligned vertically to the surface of the substrate, or horizontally or obliquely thereto.

Further, the aligned carbon nanotube bulk structure of the present invention preferably shows anisotropy between the alignment direction and the direction vertical thereto, in at least any of optical properties, electric properties, mechanical properties and thermal properties. The degree of anisotropy of the aligned carbon nanotube bulk structure between the alignment direction and the direction vertical thereto is preferably at most ⅓, more preferably at most ⅕, even more preferably at most 1/10. The lowermost limit may be about 1/100 Also preferably, the intensity ratio of the (100), (110) and (002) peaks in the alignment direction and in the direction vertical thereto in X-ray diffraction is from ½ to 1/100 in terms of the ratio of the small value to the large value. FIG. 2 shows one example of the case. Such a large anisotropy of, for example, optical properties makes it possible to apply the structure to polarizers that utilize the polarization dependency of light absorbance or light transmittance. The anisotropy of other properties also makes it possible to apply the structure to various articles that utilize the individual anisotropy.

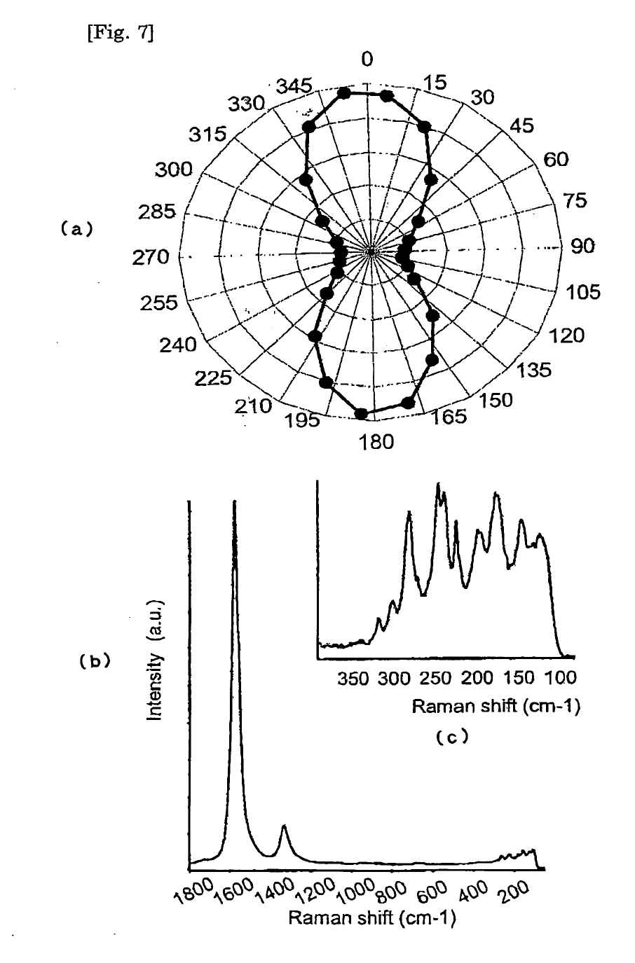

The quality of the carbon nanotubes (filaments) in the high-density portion of the aligned carbon nanotube bulk structure can be evaluated through Raman spectrometry. One example of Raman spectrometry is shown in FIG. 7. In FIG. 7, (a) shows the anisotropy of Raman G band; and (b) and (c) show data of Raman G band. From the drawings, it is known that the G band having a sharp peak is seen at 1592 kayser indicating the presence of a graphite crystal structure. In addition, it is also known that the D band is small therefore indicating the presence of a high-quality graphite layer with few defects. On the short wavelength side, seen are RBM modes caused by plural single-walled carbon nanotubes, and it is known that the graphite layer comprises a single-walled carbon nanotubes. These confirm the existence of high-quality single-walled carbon nanotubes in the aligned carbon nanotube bulk structure of the present invention. Further, it is known that the Raman G band anisotropy differs by 6.8 times between the alignment direction and the direction vertical thereto.

Further, the aligned carbon nanotube bulk structure of the present invention may be patterned in a predetermined shape. The shape includes, for example, thin films, as well as any desired blocks such as columns having a circular, oval or n-angled cross section (n is an integer of at least 3), or cubic or rectangular solids, and needle-like solids (including sharp, thin and long cones). The patterning method is described hereinunder.

Next described is a process for producing the aligned carbon nanotube bulk structure of the present invention.

The process for producing the aligned carbon nanotube bulk structure of the present invention is a process for producing an aligned carbon nanotube bulk structure having portions different in density through chemical vapor deposition (CVD) of carbon nanotubes in the presence of a metal catalyst, wherein plural carbon nanotubes are grown, as aligned, then a part of the resulting plural carbon nanotubes are exposed to liquid and thereafter dried, thereby producing an aligned carbon nanotube bulk structure having a high-density portion having a density of from 0.2 to 1.5 g/cm³ and a low-density portion having a density of from 0.001 to 0.2 g/cm³.

First described is the method of aligned growth of plural carbon nanotubes through CVD.

As the carbon compound for the starting carbon source in CVD, usable are hydrocarbons like before, and preferred are lower hydrocarbons such as methane, ethane, propane, ethylene, propylene, acetylene. One or more of these may be used, and use of lower alcohols such as methanol or ethanol, acetone, and low-carbon oxygen-containing compounds such as carbon monoxide may also be taken into consideration within an acceptable range for the reaction condition.

The atmospheric gas for reaction may be any one that does not react with carbon nanotubes and is inert at the growing temperature. Its examples include helium, argon, hydrogen, nitrogen, neon, krypton, carbon dioxide, chloride, and their mixed gases; and especially preferred are helium, argon, hydrogen and their mixed gases.

The atmospheric pressure in reaction may be any one falling within a pressure range within which carbon nanotubes can be produced, and is preferably from 10² Pa to 10⁷ Pa (100 atmospheres), more preferably from 10⁴ Pa to 3×10⁵ Pa (3 atmospheres), even more preferably from 5×10 Pa to 9×10 Pa.

As so mentioned in the above, a metal catalyst is made to exist in the reaction system, and the catalyst may be any suitable one heretofore used in production of carbon nanotubes. For example, it includes thin film of iron chloride, thin film of iron formed by sputtering, thin film of iron-molybdenum, thin film of alumina-iron, thin film of alumina-cobalt, thin film of alumna-iron-molybdenum, etc.

The amount of the catalyst may fall within any range heretofore employed in production of carbon nanotubes. For example, when an iron metal catalyst is used, then its thickness is preferably from 0.1 nm to 100 nm, more preferably from 0.5 nm to 5 nm, even more preferably from 1 nm to 2 nm.

Regarding the catalyst positioning, employable is any method of positioning the metal catalyst having a thickness as above, suitable for sputtering deposition.

The temperature in the growth reaction in CVD may be suitably determined in consideration of the reaction pressure, the metal catalyst, the carbon source material, etc.

According to the process of the present invention, a catalyst may be disposed on a substrate, and plural carbon nanotubes may be grown, as aligned vertically to the substrate surface. In this case, any substrate heretofore used in production of carbon nanotubes is employable, for example, including the following:

(1) Metals and semiconductors such as iron, nickel, chromium, molybdenum, tungsten, titanium, aluminium, manganese, cobalt, copper, silver, gold, platinum, niobium, tantalum, lead, zinc, gallium, germanium, indium, gallium, germanium, arsenic, indium, phosphorus, antimony; their alloys; and oxides of those metals and alloys.

(2) Thin films, sheets, plates, powders and porous materials of the above-mentioned metals, alloys and oxides.

(3) Non-metals and ceramics such as silicon, quartz, glass, mica, graphite, diamond; their wafers and thin films.

For the method of patterning the catalyst, employable is any suitable method capable of directly or indirectly patterning the catalyst metal. It may be a wet process or a dry process; and for example, herein employable are patterning with mask, patterning by nano-imprinting, patterning through soft lithography, patterning by printing, patterning by plating, patterning by screen printing, patterning through lithography, as well as a method of patterning some other material capable of selectively adsorbing a catalyst on a substrate and then making the other material selectively adsorb a catalyst thereby forming a pattern. Preferred methods are patterning through lithography, metal deposition photolithography with mask, electron beam lithography, catalyst metal patterning through electron beam deposition with mask, and catalyst metal patterning through sputtering with mask.

According to the process of the present invention, an oxidizing agent such as water vapor may be added to the reaction atmosphere described in Non-Patent Document 1 thereby growing a large quantity of aligned single-walled carbon nanotubes. Needless-to-say, the invention should not be limited to the process, in which, therefore, any other various processes may be employed.

In the manner as above, an aligned carbon nanotube bulk aggregate before exposed to liquid and dried may be obtained.

The method of peeling the aligned carbon nanotube bulk structure from the substrate may be a method of peeling it from the substrate physically, chemically or mechanically. For example, herein employable are a method of peeling it by the action of an electric field, a magnetic field, a centrifugal force or a surface tension; a method of mechanically peeling it directly from the substrate; and a method of peeling it from the substrate under pressure or heat. One simple peeling method comprises picking it up directly from the substrate with tweezers and peeling it. More preferably, it may be cut off from the substrate by the use of a thin cutting tool such as cutter blade. Further, it may be peeled by suction from the substrate, using a vacuum pump or a vacuum cleaner. After peeled, the catalyst may remain on the substrate, and it may be again used in the next step of growing carbon nanotubes. Needless-to-say, the aligned carbon nanotube bulk structure formed on the substrate may be directly processed as it is in the next step.

According to the process of the present application, a part of the plural aligned carbon nanotubes produced in the manner as above are exposed to liquid and then dried to give the intended aligned carbon nanotube bulk structure. The shape of the obtained structure may be controlled to various characteristic shapes, depending on the shape of the aligned carbon nanotube bulk aggregate before exposure to liquid, the starting point for exposure to liquid, the amount of the liquid for exposure thereto and the use of a shaping mold.

The liquid to which plural aligned carbon nanotubes are exposed is preferably one that has an affinity to carbon nanotubes and does not remain in the carbon nanotubes wetted with it and then dried. The liquid of the type usable herein includes, for example, water, alcohols (isopropanol, ethanol, methanol), acetones (acetone), hexane, toluene, cyclohexane, DMF (dimethylformamide), etc.

For exposing plural aligned carbon nanotubes to the above-mentioned liquid, for example, employable are a method comprising dropwise applying the liquid droplets little by little onto the upper surface of the aligned carbon nanotube structure and repeating the operation until the aligned carbon nanotube structure is finally completely enveloped by the liquid droplets; a method comprising wetting the surface of the substrate with the liquid by the use of pipette, then infiltrating the liquid into the aligned carbon nanotube structure from the point at which the structure is kept in contact with the substrate, thereby wetting entirely the aligned carbon nanotube structure; a method comprising vaporizing the liquid and exposed the entire aligned carbon nanotube structure with the vapor in a predetermined direction; a method comprising spraying the liquid onto the aligned carbon nanotube structure so as to wet it with the liquid. For drying the aligned carbon nanotube structure after wetted with the liquid, for example, employable is a method of spontaneous drying at room temperature, vacuum drying, or heating on a hot plate or the like.

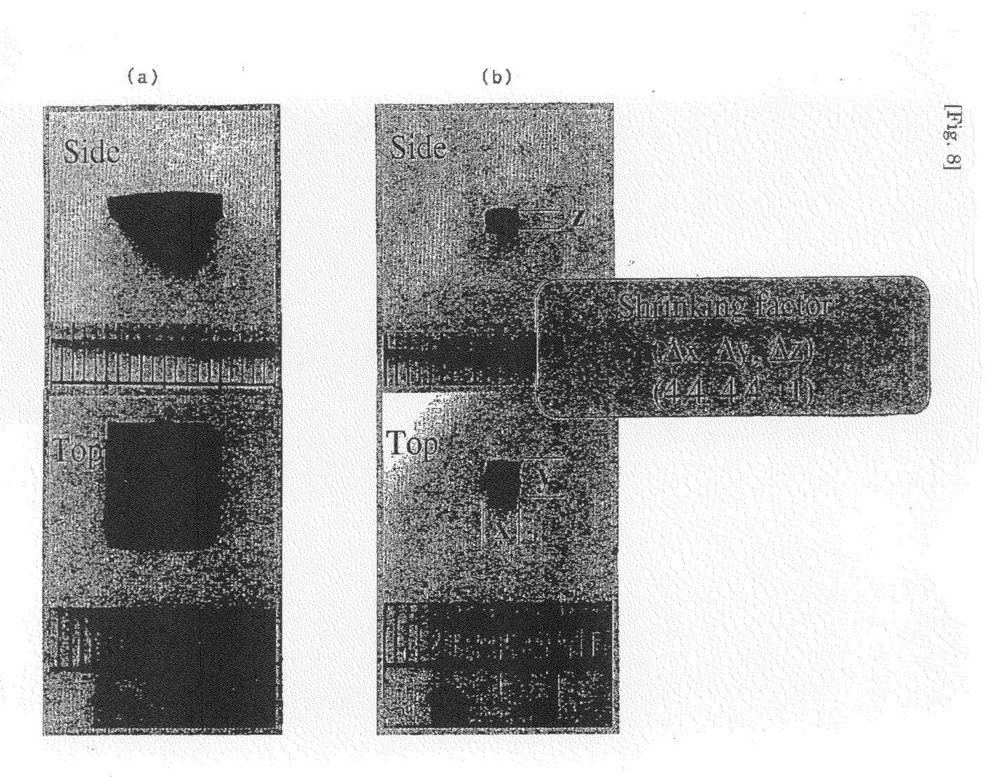

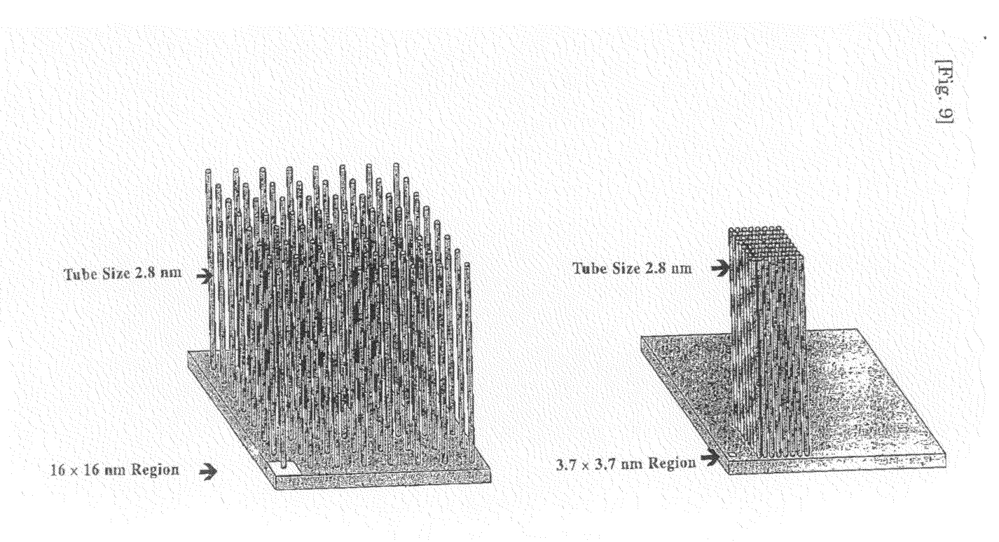

When plural aligned carbon nanotubes are exposed to the liquid, their structure may shrink a little and may much shrink when dried, thereby giving an aligned carbon nanotube bulk structure having a high density. In this case, the shrinkage is anisotropic, and one example is shown in FIG. 8. In FIG. 8, the left side shows an aligned carbon nanotube bulk structure produced according to the process of Non-Patent Document 1; and the right side shows one produced by exposing the aligned carbon nanotube bulk structure to water followed by drying. The alignment direction is z direction; and the plane vertical to the alignment direction has x direction and y direction defined therein. The shrinking image is shown in FIG. 9. Further, during exposure to solution, when weak external pressure is applied thereto, then the shape of the aligned carbon nanotube bulk structure may be controlled. For example, when the bulk structure is dipped in solution and dried while weak pressure is applied thereto in the x direction vertical to the alignment direction, then an aligned carbon nanotube bulk structure shrunk mainly in the x direction may be obtained. Similarly, when the solution dipping and drying is effected while weak pressure is applied obliquely to the alignment direction z, then a thin-filmy aligned carbon nanotube bulk structure shrunk mainly in the z direction may be obtained. The aligned carbon nanotube bulk structure may be processed according to the above process, after it is removed from the substrate on which it has grown, then it is placed on another substrate. In this case, it is possible to produce an aligned carbon nanotube bulk structure having high adhesiveness to any desired substrate. For example, in case where a thin-filmy aligned carbon nanotube bulk structure is formed on a metal, then it may have high electric conductivity adjacent to a metal electrode, and for example, it may be favorably utilized in an application of electroconductive materials for heater or capacitor electrodes. In this case, the pressure may be weak in such a level of picking up with tweezers, and it does not cause damage to the carbon nanotubes. Pressure alone could not compress the bulk structure to have the same degree of shrinkage not causing damage to the carbon nanotubes, and it is extremely important to use solution for producing a favorable aligned carbon nanotube bulk structure.

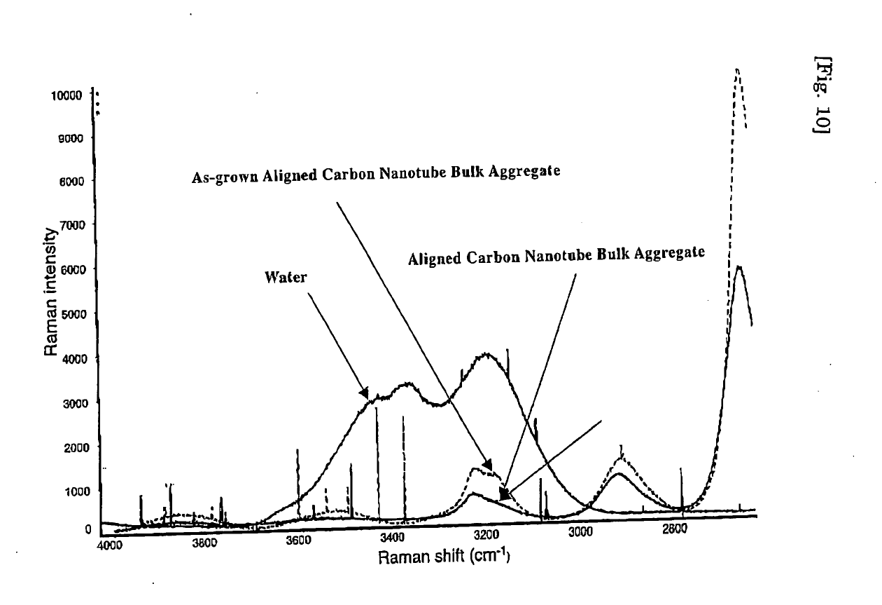

Raman data of the high-density portion of the aligned carbon nanotube bulk structure produced by exposing a part of plural aligned carbon nanotubes to water followed by drying are shown in FIG. 10 as one example. This drawing shows no water remaining in the dried bulk structure.

Some examples of producing the aligned carbon nanotube bulk structure having a high-density portion and a low-density portion are described below.

As shown in FIG. 9, when a part of the aligned carbon nanotube bulk aggregate as-grown is exposed to liquid and thereafter dried, it is known that the part is shrunk, and for example, it forms a high-density portion having a density of about 20 times higher than the density before exposure to liquid. In addition, it is also known that when the starting point for exposure to liquid is varied in aligned carbon nanotube aggregates having the same shape, then they give quite different shapes. The shrinkage depends on the aspect ratio (length/width ratio) of the aligned carbon nanotube bulk aggregate before exposure to liquid and on the existence and the profile of the surface thereof. Further, when a columnar aligned carbon nanotube bulk aggregate having a small aspect ratio is exposed to liquid and thereafter dried, then it forms voids running along the axis thereof. A columnar aligned carbon nanotube bulk aggregate having a large aspect ratio is extremely influenced by the shrinkage starting point. Taking such various conditions into consideration, an aligned carbon nanotube bulk structure having any desired shape and having a high-density portion and a low-density portion can be produced.

FIG. 11 shows some shape examples.

(a) A catalyst is circularly patterned, then carbon nanotubes are grown, and a pillar-structured aligned carbon nanotube bulk aggregate is produced on a substrate. In this case, it is produced in such a manner that the adhesiveness between the aligned carbon nanotube bulk aggregate and the substrate could be low. The surface of the substrate on which the aligned carbon nanotube bulk aggregate is grown is wetted with a minor amount of liquid so that the aligned carbon nanotube aggregate could be immersed with the liquid from the point at which it is kept in contact with the substrate, whereby the lower part is shrunk and densified to have a high density. In this case, the amount of the liquid to be given is controlled, and the upper part is kept to have a low density after grown. Since the interaction between the substrate and the aligned carbon nanotube bulk aggregate is weak, the aligned carbon nanotube bulk aggregate peels off from the substrate during shrinking, thereby forming a balloon-shaped aligned carbon nanotube bulk aggregate structure.

(b) A catalyst is circularly patterned, then carbon nanotubes are grown, and a pillar-structured aligned carbon nanotube bulk aggregate is produced on a substrate. In this case, it is produced in such a manner that the adhesiveness between the aligned carbon nanotube bulk aggregate and the substrate could be high. The surface of the substrate on which the aligned carbon nanotube bulk aggregate is grown is wetted with a minor amount of liquid so that the aligned carbon nanotube aggregate could be immersed with the liquid from the point at which it is kept in contact with the substrate, whereby the lower part is shrunk and densified to have a high density. In this case, the amount of the liquid to be given is controlled, and the upper part is kept to have a low density after grown. Since the interaction between the substrate and the aligned carbon nanotube bulk aggregate is strong, the aligned carbon nanotube bulk aggregate is still held on the substrate during shrinking, thereby forming a mortar-shaped aligned carbon nanotube bulk aggregate structure.

(c) The same operation as in (b) is repeated for an angular aligned carbon nanotube bulk aggregate.

(d) The aligned carbon nanotube aggregate is peeled from the substrate, using tweezers, and then cleaved by hand and using tweezers, in such a manner that the alignment direction could be in the lengthwise direction, thereby working it to have a shape of rod; and then the lower part of the rod is picked up with tweezers, the picked part is exposed to an extremely minor amount of water so that only the water-exposed part could be shrunk and densified to have a high density, and thereafter this is put on a hot plate kept at 170° C. and dried thereon.

Application examples of the aligned carbon nanotube bulk structure of the present invention are shown below, to which, needless-to-say, the invention should not be limited.

<1> CNT brush
<2> Contact of commutator
<3> Axis of commutator

The high-density portion of the aligned carbon nanotube bulk structure of the present invention has an extremely large density and a high hardness as compared with conventional aligned carbon nanotube bulk aggregates or structures. Further, in the aligned carbon nanotube bulk structure having the high-density portion and the low-density portion, the high-density portion and the low-density portion have various properties and characteristics such as ultra high purity, ultra heat conductivity, high specific surface area, excellent electronic and electric properties, optical properties, ultra mechanical strength, ultra high density, etc., respectively; and therefore, they can be applied to various technical fields as mentioned below.

### EXAMPLES

Examples are shown below, and described in more detail. Needless-to-say, the present invention should not be limited to the following Examples.

### Example 1

### CNT Brush

An aligned carbon nanotube aggregate was grown through CVD under the condition mentioned below.

Carbon compound: ethylene, feeding speed 100 sccm
Atmosphere (gas) (Pa): helium/hydrogen mixed gas, feeding speed 1000 sccm, one atmospheric pressure
Water vapor amount added (ppm): 150 ppm
Reaction temperature (° C.): 750° C.
Reaction time (min): 10 min
Metal catalyst (existing amount): thin iron film, thickness 1 nm
Substrate: silicon wafer

A sputtering vapor deposition device was used for disposing the catalyst on the substrate; and an iron metal having a thickness of 1 nm was disposed through vapor deposition.

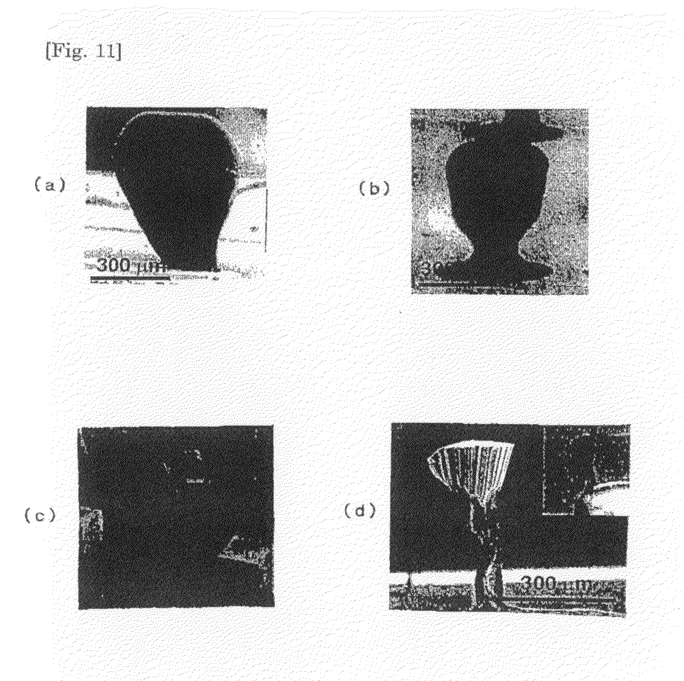

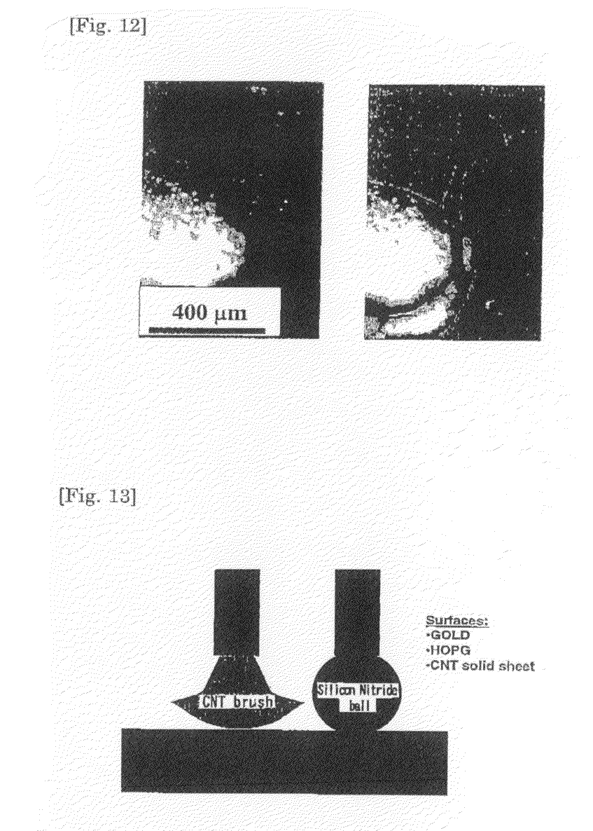

Next, the aligned carbon nanotube aggregate produced in the above was peeled from the substrate, using tweezers, and then cleaved by hand and using tweezers, in such a manner that the alignment direction could be in the lengthwise direction, thereby working it to have a shape of rod; and then the lower part of the rod was picked up with tweezers. The part picked up with tweezers was exposed to an extremely minor amount of water so that only the water-exposed part could be shrunk and densified to have a high density, and thereafter this was put on a hot plate kept at 170° C. and dried thereon. Accordingly, a CNT brush comprising the aligned carbon nanotube bulk structure of the present invention was produced, as in FIG. 12, in which the high-density portion is a handle and the low-density portion not wetted with water is a brush top and the two portions bond to each other with keeping the integrated structure in the interface thereof.

The characteristics of the high-density portion (handle) and the low-density portion (brush top) of the thus-obtained aligned carbon nanotube bulk structure (CNT brush) are shown in Table 1, as compared with each other.

TABLE 1

| | Low-Density | High-Density |
|---|---|---|
| | Portion | Portion |
| Density (g/cm³) | 0.029 | 0.57 |
| Nanotube Density (number of | 4.3 × 10¹¹ | 8.3 × 10¹² |
| nanotubes/cm²) | | |
| Area per one nanotube | 234 nm² | 11.9 nm² |
| Coating Ratio | about 3% | 53% |
| Vickers Hardness | about 0.1 | 7 to 10 |

The purity of the aligned carbon nanotube bulk aggregate of Example 1 was 99.98%.

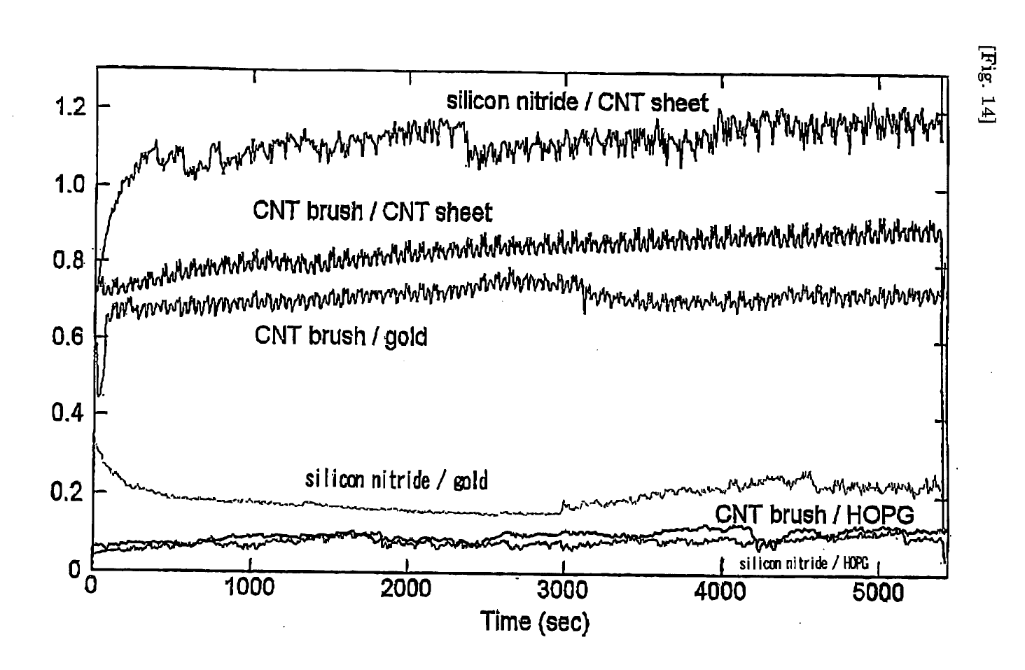

Next, the friction property of the CNT brush of Example 1 and that of a silicon nitride ball were investigated, as in the image of FIG. 13. Objects used for frictional investigation were gold, high oriented pyrolytic graphite (HOPG), and aligned carbon nanotube bulk sheet (high density). The results are shown in FIG. 14. The graph confirms the low-friction property of the CNT brush of Example 1.

### Example 2

### Electric Contact for Motor (Brush)

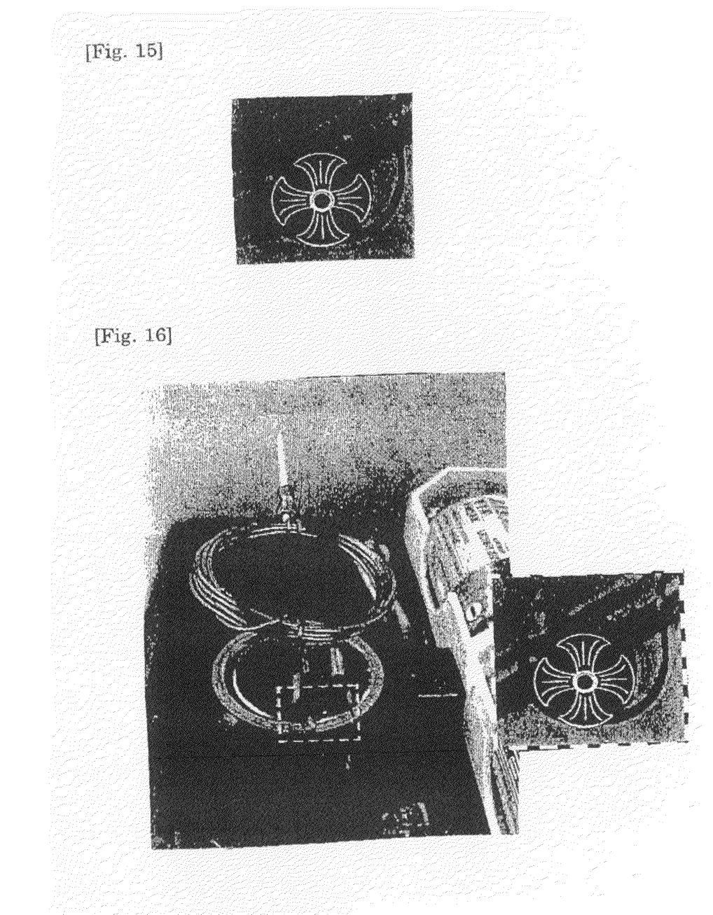

In Example 1, the aligned carbon nanotube bulk aggregate as-grown was cut into strips with the alignment direction being the lengthwise direction thereof, and the center part of the strip was exposed to water and then dried to form a commutator having the shape shown in FIG. 15. The commutator comprises four fan-shaped parts, in which the center side of each fan-shaped part is a high-density portion and the peripheral side thereof is a low-density portion, This was tested as in the constitution shown in FIG. 16, which confirmed the role of the structure as an electric contact for good contact with a copper commutator at low friction therebetween. In this, the density of the high-density portion was 0.5 g/cm³, and the density of the low-density portion was 0.03 g/cm³. The electric contact for CNT motor may also play a role as the axis thereof.

1-35. (canceled)

36. An aligned carbon nanotube bulk structure having portions different in density, in which plural carbon nanotubes are aligned in a predetermined direction and which has a high-density portion having a density of from 0.2 to 1.5 g/cm³ and a low-density portion having a density of from 0.001 to 0.2 g/cm³.

37. The aligned carbon nanotube bulk structure having portions different in density as claimed in claim 36, which has one or more intermediate density portions falling between the high-density portion and the low-density portion.

38. The aligned carbon nanotube bulk structure having portions different in density as claimed in claim 36, wherein the high-density portion and the low-density portion are disposed regularly.

39. The aligned carbon nanotube bulk structure having portions different in density as claimed in claim 36, wherein the high-density portion and the low-density portion and the intermediate-density portion are disposed regularly.

40. An aligned carbon nanotube bulk structure having portions different in density, in which plural carbon nanotubes are aligned in a predetermined direction and of which the density continuously or stepwise changes between the highest-density portion having a density of from 0.2 to 1.5 g/cm³ and a lowest-density portion having a density of from 0.001 to 0.2 g/cm³.

41. The aligned carbon nanotube bulk structure having portions different in density as claimed in claim 36, wherein the carbon nanotubes are single-walled carbon nanotubes.

42. The aligned carbon nanotube bulk structure having portions different in density as claimed in claim 36, wherein the carbon nanotubes are double-walled carbon nanotubes.

43. The aligned carbon nanotube bulk structure having portions different in density as claimed in claim 36, wherein the carbon nanotubes are a mixture of single-walled carbon, nanotubes and double-walled or more multi-walled carbon nanotubes.

44. The aligned carbon nanotube bulk structure having portions different in density as claimed in claim 36, which has a purity of at least 98 mass %.

45. The aligned carbon nanotube bulk structure having portions different in density as claimed in claim 36, the high-density portion of which has a specific surface area of from 600 to 2600 m²/g.

46. The aligned carbon nanotube bulk structure having portions different in density as claimed in claim 36, the high-density portion of which is unopened and which has a specific surface area of from 600 to 1300 m²/g.

47. The aligned carbon nanotube bulk structure having portions different in density as claimed in claim 36, the high-density portion of which is opened and which has a specific surface area of from 1300 to 2600 m²/g.

48. The aligned carbon nanotube bulk structure having portions different in density as claimed in claim 36, the high-density portion of which is a mesoporous material having a packing ratio of from 5 to 50%.

49. The aligned carbon nanotube bulk structure having portions different in density as claimed in claim 36, the high-density portion of which has a mesopore diameter of from 1.0 go 5.0 nm.

50. The aligned carbon nanotube bulk structure having portions different in density as claimed in claim 36, the high-density portion of which has a Vickers hardness of from 5 to 100 HV.

51. The aligned carbon nanotube bulk structure having portions different in density as claimed in claim 36, the high-density portion of which is vertically aligned or horizontally aligned on a substrate.

52. The aligned carbon nanotube bulk structure having portions different in density as claimed in claim 36, the high-density portion of which is aligned on a substrate in the direction oblique to the substrate surface.

53. The aligned carbon nanotube bulk structure having portions different in density as claimed in claim 36, the high-density portion of which has anisotropy between the alignment direction and the direction vertical thereto, in at least any of optical properties, electric properties, mechanical properties and thermal properties.

54. The aligned carbon nanotube bulk structure having portions different in density as claimed in claim 36, wherein the degree of anisotropy of the high-density portion between the alignment direction and the direction vertical thereto is at most ⅕ in terms of the ratio of the small value to the large value.

55. The aligned carbon nanotube bulk structure having portions different in density as claimed in claim 36, wherein the intensity ratio of any of the (100), (110) and (002) peaks of the high-density portion in the alignment direction and in the direction vertical thereto in X-ray diffraction is from ½ to 1/100 in terms of the ratio of the small value to the large value.

56. The aligned carbon nanotube bulk structure having portions different in density as claimed in claim 36, wherein the shape of the high density portion is a thin film.

57. The aligned carbon nanotube bulk structure having portions different in density as claimed in claim 36, wherein the shape of the high-density portion is a columnar one having a circular, oval or n-angled cross section (n is an integer of at least 3).

58. The aligned carbon nanotube bulk structure having portions different in density as claimed in claim 36, wherein the shape of the high-density portion is a block.

59. The aligned carbon nanotube bulk structure having portions different in density as claimed in claim 36, wherein the shape of the high-density portion is a needle-like one.

60. A process for producing an aligned carbon nanotube bulk structure having portions different in density as claimed in claim 36 through chemical vapor deposition (CVD) of carbon nanotubes in the presence of a metal catalyst, wherein plural carbon nanotubes are grown, as aligned, then a part of the resulting plural carbon nanotubes are exposed to liquid and thereafter dried, thereby producing an aligned carbon nanotube bulk structure having a high-density portion having a density of from 0.2 to 1.5 g/cm³ and a low-density portion having a density of from 0.001 to 0.2 g/cm³.

61. The process for producing an aligned carbon nanotube bulk structure having portions different in density as claimed in claim 60, wherein the starting point to be exposed to liquid is changed to thereby produce an aligned carbon nanotube bulk structure having a different shape.

62. The process for producing an aligned carbon nanotube bulk structure having portions different in density as claimed in claim 60, wherein in exposing plural carbon nanotubes to liquid and drying them, pressure of a different level is given thereto in different directions.

63. The process for producing an aligned carbon nanotube bulk structure having portions different in density as claimed in claim 60, wherein the shape of the aligned carbon nanotube bulk structure is controlled by a shaping mold.

64. A functional product comprising an aligned carbon nanotube bulk structure having portions different in density, in which plural carbon nanotubes are aligned in a predetermined direction and which has a high-density portion having a density of from 0.2 to 1.5 g/cm³ and a low-density portion having a density of from 0.001 to 0.2 g/cm³.

65. The functional product as claimed in claim 64, which is a brush for cleaning and in which the high-density portion is formed as an axis, and from its one end, the low-density portion expands like plural hairs.

66. The functional product as claimed in claim 64, which is a motor brush.

67. The functional product as claimed in claim 64, which is a motor commutator.

68. The functional product as claimed in claim 64, which is an electric contact of motor.

69. The functional product as claimed in claim 64, which constitutes a slide member.

70. The functional product as claimed in claim 64, which is an optical member.
